(19) United States
(12) Patent Application Publication
(10) Pub. No.: US 2026/0017660 A1
(43) Pub. Date: Jan. 15, 2026

(54) METHOD FOR DETECTING FRAUD IN FINANCIAL TRANSACTIONS

(71) Applicant: RAPTORXAI PRIVATE LIMITED, Tellapur (IN)

(72) Inventor: Pratyusha Vemuri Venkata, Tellapur (IN)

(21) Appl. No.: 19/255,623

(22) Filed: Jun. 30, 2025

(30) Foreign Application Priority Data
Jul. 10, 2024 (IN) 202441052872

(51) Int. Cl. G06Q 20/40

(52) U.S. Cl. CPC G06Q 20/4016

(57) ABSTRACT

The invention provides a method for detecting fraud in financial transactions using a graph link attention network. The method involves constructing a transaction network where nodes represent transaction accounts and links represent transaction behaviors. Node features are extracted through a linear neural network, resulting in transformed node features. Link features are extracted and processed using a multi-head attention mechanism to generate link importance scores, with each score indicating the impact of the link on its corresponding node, and the total importance scores for each node summing to one. These transformed node features and link importance scores are combined to form mixed features, which are then utilized to identify fraudulent transactions within the transaction network. This approach enhances the accuracy and efficiency of fraud detection by focusing on the critical links in the transaction network.

### FIELD OF THE INVENTION

The invention pertains to the field of financial transaction security and fraud detection systems. Specifically, the invention relates to advanced fraud detection methods designed to improve the accuracy and efficiency of identifying fraudulent activities through a graph link attention network, leveraging link information, attention mechanisms, and efficient matrix computations for scalable and explainable fraud detection in large transaction networks.

### BACKGROUND OF THE INVENTION

Traditional methods for detecting fraud in financial transactions primarily rely on rule-based systems and statistical analysis. Rule-based approaches are built on predefined rules to flag suspicious transactions, but they struggle to adapt to evolving fraud techniques. Similarly, statistical methods analyze historical transaction data to detect patterns indicative of fraud. However, these methods often encounter challenges such as data sparsity and the need for complex feature engineering, limiting their effectiveness in dynamic environments.

In recent years, machine learning (ML) techniques have gained prominence in fraud detection due to their ability to learn from data. However, traditional ML methods typically focus solely on transaction attributes, overlooking the interdependencies and relationships within transaction networks. This oversight poses significant limitations.

Firstly, traditional approaches often fail to detect sophisticated fraudulent behaviors that involve multiple accounts or transactions. The inability to comprehensively utilize transaction network information, including account relationships, hampers the detection of complex fraud schemes.

Existing solutions that leverage graph neural networks (GNNs) attempt to address these challenges by capturing relational information in transaction networks. However, many GNN-based approaches still underutilize the structural insights provided by the graph topology. Particularly in tasks where the relationships (or links) between accounts hold greater significance than individual account attributes, the efficacy of existing models diminishes.

Furthermore, the scalability of graph-based models remains a critical concern. The computational resources required to train and apply these models escalate with the size of the dataset, especially when dealing with large-scale transaction networks comprising millions of connections. This scalability issue not only increases processing times but also limits the practical deployment of graph-based fraud detection systems in real-world scenarios.

Moreover, the dynamic nature of financial fraud necessitates continuous adaptation of detection methodologies. Rule-based systems, reliant on static rules, struggle to keep pace with evolving fraud tactics that exploit loopholes and adapt to circumvent predefined criteria. This limitation results in a perpetual game of catch-up, where fraudsters often stay a step ahead by exploiting new vulnerabilities that rule-based systems fail to anticipate or address in real-time.

Statistical methods, while offering insights into transaction patterns, face inherent challenges in extracting meaningful features from sparse and noisy data. This issue is compounded in scenarios where fraudulent activities mimic legitimate transactions, making it difficult to discern anomalous behavior solely based on statistical deviations. The complexity of financial ecosystems further exacerbates these challenges, as transactions involve varied entities with interconnected relationships that evolve over time.

Furthermore, the computational demands of traditional graph-based networks pose a barrier to their widespread adoption. The sheer volume of data processed in financial transaction networks necessitates efficient algorithms capable of handling large-scale datasets without compromising on accuracy or speed. Current implementations often struggle to strike a balance between computational efficiency and the nuanced analysis required to detect subtle patterns indicative of fraudulent activity.

### SUMMARY OF THE INVENTION

To address the foregoing problems, in whole or in part, and/or other problems that may have been observed by persons skilled in the art, the present disclosure provides compositions and methods as described by way of example as set forth below.

The principal objective of the present invention is to develop a method that leverages link information in financial transaction networks to more accurately identify complex fraudulent behaviors involving multiple accounts or transactions.

Another objective of the invention is to implement memory-efficient attention mechanisms and advanced matrix computation techniques to handle large datasets with millions of connections, making the model practical for real-world financial systems.

Another objective of the invention is to utilize link importance scores to reveal latent patterns in account relationships, aiding in the detection of sophisticated fraud schemes that traditional methods might miss.

Another objective of the invention is to provide a method that outputs link importance scores for visualization in 2D or 3D, facilitating intuitive understanding of relationships between accounts and aiding in the identification of suspicious links.

In view of the foregoing, the present invention provides a method for detecting fraud in financial transactions via a graph link attention network, comprising constructing a transaction network having nodes representing transaction accounts and links representing transaction behaviors; extracting node features by a linear neural network to obtain transformed node features; extracting link features, followed by applying a multi-head attention mechanism to generate link importance scores, wherein the link importance score for each link represents its impact on the corresponding node and the sum of the importance scores for all links of each node equals 1; combining the transformed node features and the link importance scores to form mixed features; and utilizing the mixed features to identify fraudulent transactions within the transaction network.

In another aspect, the node features include at least one of the following: basic information of the trading account, transaction type, and transaction amount.

In another aspect, the transaction network is visualized in a 2D or 3D graph based on the link importance scores to facilitate the identification of suspicious links.

In another aspect, the multi-head attention mechanism applies multiple sets of attention functions in parallel to the link features to enhance the learning of link importance scores.

In another aspect, the mixed features are used for recommendation systems to suggest potential transactions between accounts based on their relationships within the transaction network.

In another aspect, the model outputs a fraud likelihood score for each node based on the combined link importance scores and node feature.

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 illustrates framework for fraud detection in financial transactions, in accordance with an embodiment of the present invention;

FIG. 2 illustrates a network of financial transaction accounts, in accordance with an embodiment of the present invention;

FIG. 3 illustrates confusion matrix on the test dataset of the Amazon Fraud Benchmark, in accordance with an embodiment of the present invention;

FIG. 4 illustrates visualization on amazon fraud dataset, in accordance with an embodiment of the present invention;

FIG. 5 illustrates visualization on Amazon fraud dataset using GAT, in accordance with an embodiment of the present invention;

FIG. 6 illustrates visualization on Amazon fraud dataset using GCN, in accordance with an embodiment of the present invention;

FIG. 7 illustrates architecture of the link attention network, in accordance with an embodiment of the present invention;

Skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and example of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The present disclosure relates to an advanced method for detecting fraud in financial transactions utilizing a graph link attention network. This method addresses the limitations of existing graph neural networks, which often overlook the significance of link features in favor of node attributes. In financial transaction networks, the interactions between accounts (represented as links) are often more critical than the individual account details (represented as nodes). The invention constructs a transaction network where nodes represent transaction accounts and links represent transaction behaviors, such as the transfer of funds between accounts.

A key aspect of the invention is the extraction and transformation of node and link features. Node features, which include basic account information, transaction types, and amounts, are processed through a linear neural network to obtain transformed node features. Simultaneously, link features undergo a linear transformation followed by a multi-head attention mechanism, which calculates link importance scores. These scores reflect the impact of each link on its corresponding nodes and sum to one for each node, ensuring a normalized representation of link significance within the network.

The mixed features, comprising the transformed node features and link importance scores, are then used to detect fraudulent transactions. By focusing on the most important links, the model can accurately identify complex fraudulent behaviors involving multiple accounts or transactions. This approach not only improves detection accuracy but also enhances the explainability of the model's decisions. The link importance scores can be visualized in 2D or 3D, providing an intuitive understanding of the relationships and connections between accounts, which is invaluable for uncovering sophisticated fraud schemes.

Scalability and efficiency are also central to the invention. The method employs advanced mathematical techniques for matrix computation, reducing the computational complexity and memory consumption typically associated with graph-based models. This results in faster training and inference speeds, making the model practical for large-scale datasets with millions of connections. This memory-efficient optimization ensures that the model can be applied in real-world financial systems without prohibitive resource requirements.

Beyond fraud detection, the invention demonstrates versatility across various applications. The mixed features generated by the model can be used for node classification, predicting the likelihood of links between nodes, and recommending transactions or connections based on learned relationships. This broad applicability underscores the robustness of the graph link attention network in addressing multiple tasks within financial transaction networks, offering a comprehensive solution for enhancing transaction security and fraud prevention.

The present invention addresses the existing challenges through innovative technical solutions designed to enhance fraud detection in financial transactions. Firstly, the method uses a graph-based approach, constructing a transaction network where nodes represent transaction accounts and links depict transaction behaviors. This representation allows for a holistic view of transactional relationships, capturing crucial interactions that traditional methods often overlook.

The graph link attention network model integrates a multi-head attention mechanism to prioritize and learn the structural features of links and node attributes within the transaction network. By focusing on the importance of each link, the model can discern subtle but critical patterns that may indicate fraudulent behaviors across interconnected accounts.

Moreover, the invention emphasizes explainability through its output of link importance scores. These scores quantify the significance of each link in the network, facilitating intuitive visualizations in 2D or 3D graphs. This visualization capability enables analysts to easily identify prominent links and visualize relationships between accounts, thereby enhancing the interpretability of fraud detection outcomes.

Furthermore, the model is capable of uncovering latent relationships and hidden patterns within account interactions. By leveraging advanced graph analytics, it can identify non-obvious connections between accounts, which are often indicative of sophisticated fraud schemes designed to evade detection by traditional methods.

From a computational standpoint, the invention optimizes efficiency through mathematical techniques in matrix computation. These optimizations reduce the computational complexity associated with processing large-scale transaction datasets, thereby conserving GPU resources and accelerating both model training and inference speeds. This efficiency is crucial for real-time fraud detection and scalability in financial systems processing vast volumes of transactional data.

The method extends beyond fraud detection alone. It supports various tasks within financial transaction networks, including node classification to identify fraudulent accounts, link prediction to forecast future transactions between accounts, and recommendation systems to suggest relevant actions based on account relationships. This multifaceted approach underscores the broad applicability and robustness of the invention across diverse financial applications, enhancing overall transaction security and operational efficiency.

The invention introduces a financial transaction fraud detection model utilizing a graph link attention network. This model effectively learns and integrates the structural features of links and node attributes within transaction networks, significantly enhancing its ability to accurately identify fraudulent transaction.

Further, it proposes a method for learning link importance through an attention mechanism. By dynamically assessing and assigning importance scores to each link based on its impact on the corresponding node, the model can prioritize critical links crucial for detecting fraudulent activities. This attention mechanism optimizes the model's focus, ensuring robust fraud detection capabilities.

Further, it introduces a memory-efficient optimization technique based on advanced matrix computations. This approach mitigates computational complexities and reduces memory usage during model operations, thereby accelerating both training and inference speeds. Such efficiencies are pivotal for practical implementation in large-scale financial environments, where processing efficiency is paramount for real-time fraud detection and response.

Together, these inventive points underscore the innovation's comprehensive approach to enhancing fraud detection efficacy, scalability, and operational efficiency in financial transaction networks. By leveraging advanced graph analytics, attention mechanisms, and computational optimizations, the invention represents a significant advancement towards combating increasingly sophisticated fraudulent activities in modern financial ecosystems.

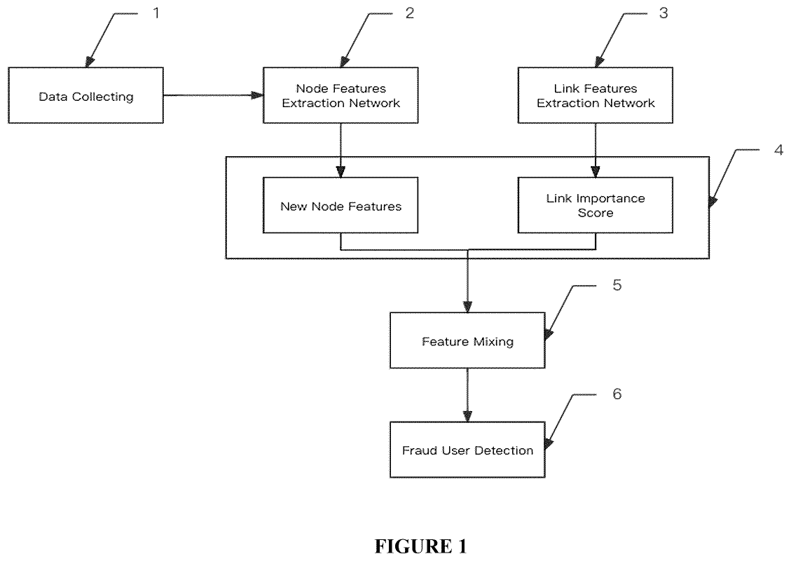

In accordance with an embodiment of the present invention, FIG. 1 shows the framework for fraud detection in financial transactions.

### Step 1: Data Collection:

The data utilized in this invention comprises historical transaction data from financial transactions. The specific node features include basic information of the trading account, transaction type, and transaction amount. The links between nodes represent transaction behaviors between two accounts, with each financial transaction establishing a link between the respective nodes and the initial link weight set to 1. Data labels are used to indicate whether a node represents a financial fraud user, with a label value of 1 indicating fraud and 0 indicating non-fraud.

### Step 2: Node Feature Extraction Network:

A linear neural network is employed to extract node features from the training set, resulting in new node features after linear transformation.

### Step 3: Link Feature Extraction Network:

Link features undergo linear transformation, followed by the application of a multi-head attention mechanism, which outputs the link importance score.

### Step 4: Feature Mixing:

The new node features obtained in Step 2 and the link importance scores obtained in Step 3 are combined. The resulting mixed feature, generated in Step 4, encompasses both the original node features and the specific impact of each link on a node.

### Step 5: Fraud User Detection:

The mixed feature is utilized to perform the task of fraud user detection in financial transactions.

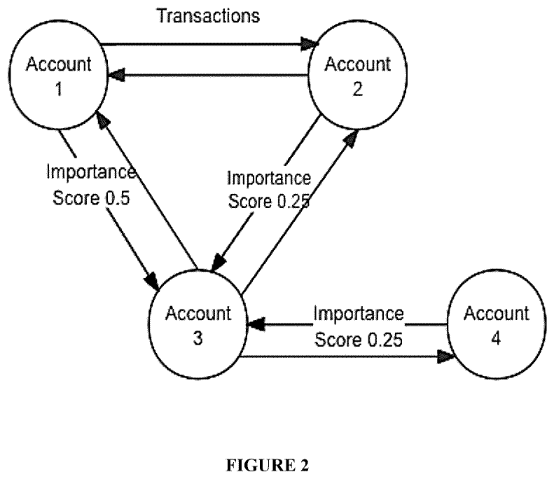

In accordance with an embodiment of the present invention, the data structure of the present invention, as illustrated in FIG. 2, represents a network of financial transaction accounts. In this structure, each node corresponds to an individual account involved in financial transactions. For example, accounts 1, 2, and 3 may have exchanged funds with one another, while accounts 3 and 4 may have also conducted transactions. These interactions are depicted as links between the nodes, illustrating the flow of money within the transaction network.

A crucial aspect of this data structure is the Link Importance Score. This score, generated by the model, quantifies the significance of each link in relation to its corresponding node. The value of the link importance score ranges from 0 to 1, with the sum of the importance scores for all links connected to a node equating to 1. This scoring mechanism ensures that the model can accurately assess and prioritize the impact of each transactional link, enhancing the detection of fraudulent activities by highlighting the most critical connections within the network.

### Accuracy on Traditional Graph Benchmarks

Accuracy: test on benchmarks of public graph dataset. For reproduction, random_seed is set to 42 in the code.

TABLE 1
Summary of results in terms of classification
accuracies, for Cora, Citeseer and Pubmed

| Method | Cora | Citeseer | Pubmed |
|---|---|---|---|
| GCN (Kipf & & | 81.5% | 70.3% | 79.0% |
| Welling, 2017) | | | |
| GAT (Veličković | 82.1% | 71.0% | 78.0% |
| et. al, 2018) | | | |
| Link Attention | 81.9% | 71.2% | 78.1% |
| Network(ours) | | | |

TABLE 2
Summary of accuracy results in terms of classification
accuracies, for Yelp and Amazon

| Method (homogeneous) | Yelp | Amazon |
|---|---|---|
| GCN (Kipf & & Welling, | 85.86% | 89.36% |
| 2017) | | |
| GAT (Veličković et. al, 2018) | 85.36% | 10.64% |
| LAN(ours) | 85.83% | 87.57% |

### F1-Macro and AUC-ROC on Fraud Benchmarks

F1-macro and AUC-ROC: test on benchmarks of fraud benchmarks. For reproduction, random_seed is set to 42 in the code.

TABLE 3
Summary of results in terms of F1-macro and AUC-
ROC, for Fraud Detection benchmark Yelp and Amazon.

| | Yelp | Yelp | Amazon | Amazon |
|---|---|---|---|---|
| CX | F1-macro | AUC-ROC | F1-macro | AUC-ROC |
| GCN (Kipf & & | 46.20 | 57.16 | 47.19 | 79.74 |
| Welling, 2017) | | | | |
| GAT (Veličković | 46.19 | 53.89 | 9.62 | 50.00 |
| et. al, 2018) | | | | |
| LAN(ours) | 46.19 | 73.46 | 73.46 | 85.41 |

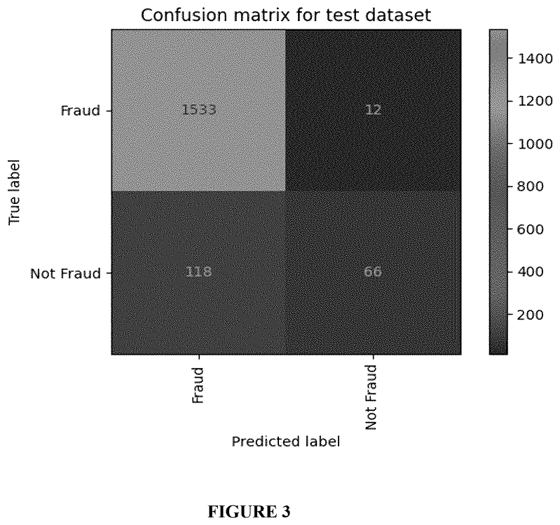

In accordance with an embodiment of the present invention, FIG. 3: Confusion matrix on the test dataset of the Amazon Fraud Benchmark. The invention converts the original heterograph graph to the homogeneous graph.

### Yelp

Nodes: 45,954
Edges (heterograph graph):
R-U-R: 98,630
R-T-R: 1,147,232
R-S-R: 6,805,486
Classes:
Positive (spam): 6,677
Negative (legitimate): 39,277
Positive-Negative ratio: 1:5.9
Node feature size: 32

### Amazon

Nodes: 11,944
Edges (heterograph graph):
U-P-U: 351,216
U-S-U: 7,132,958
U-V-U: 2,073,474
Classes:
Positive (fraudulent): 821
Negative (benign): 7,818
Unlabeled: 3,305
Positive-Negative ratio: 1:10.5
Node feature size: 25

### Model Results Visualization & Comparison

### LAN Visualization

Amazon dataset
Original number of links: 822873
threshold: 99.9%
Number of links with importance score>=threshold %: 82
Time spent on CPU: 283.72 s

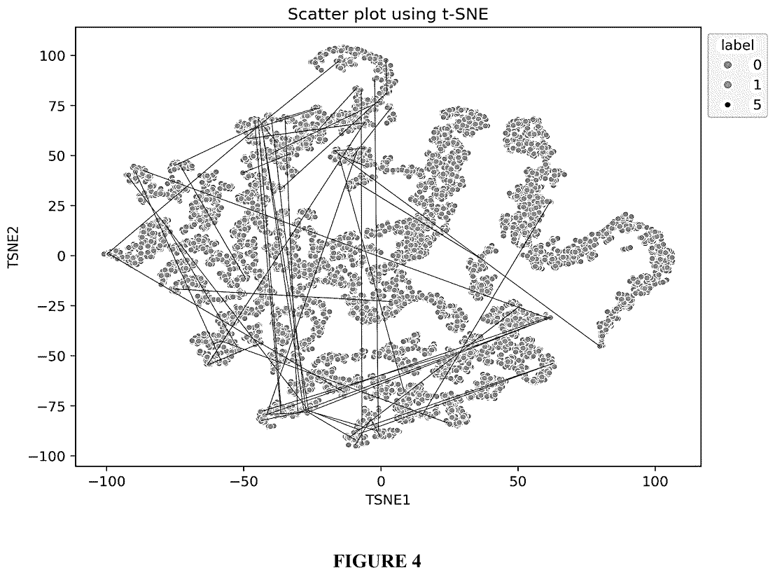

In accordance with an embodiment of the present invention, FIG. 4 illustrates visualization on amazon fraud dataset, orange node represents the fraud node, green node represents normal node. The red link between each node represents the importance score of the current link is >=threshold %.

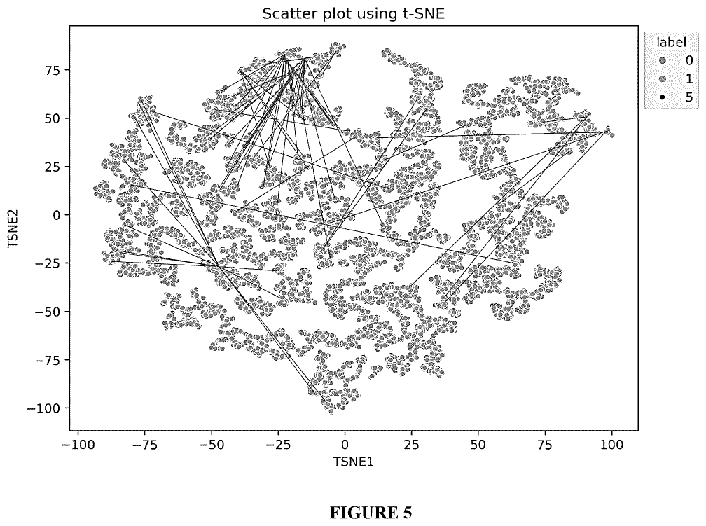

In accordance with an embodiment of the present invention, FIG. 5 illustrates visualization on Amazon fraud dataset using GAT, orange node represents the fraud node, green node represents normal node. The red link between each node represents the attention score of the current link is >=threshold %.

While the other model also uses attention links, visualizing them doesn't seem to effectively illustrate the fraud patterns, unlike our proposed model.

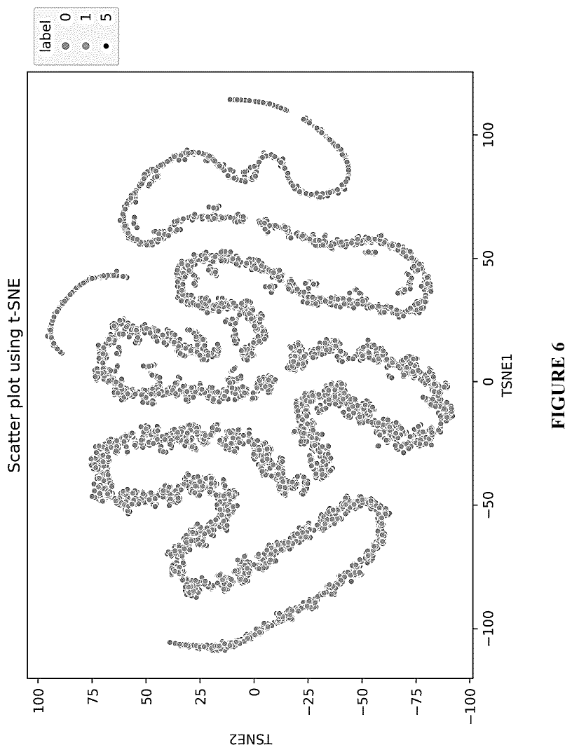

In accordance with an embodiment of the present invention, FIG. 6 illustrates visualization on Amazon fraud dataset using GCN, orange node represents the fraud node, green node represents normal node. The GCN model doesn't assign scores to connections between nodes because it ignores information about those connections. This means it only shows the raw network with millions of links, which is overwhelming to visualize and lacks the ability to highlight hidden fraud patterns.

### Model Description:

Assume there is a node matrix that is used as the input feature for the first part of the model. The matrix has N nodes, and each node contains F features.

For the first part of the model, the original node features H is used as the input of a single linear neural network. The matrix shape of the original node features H is N—by—F. Combining it with the weight matrix W_{H} ∈ [symbol] , F′ represents the output size after this linear transformation, then results in the output H′.

The output H′ can be represented as follows, and h′ᵢ represents the output feature of node i in this layer.

$${H}^{′} = {HW}_{H}$$

Therefore, the shape of output H′ is N—by—F′.

In addition to these details, there is also an adjacency matrix E, which represents the relationship of each node in the graph structure data.

Here is the second part of the model: Link-based Attention Structure.

In this innovation, in order to transform the original adjacency matrix into a more powerful and expressive high-level adjacency matrix, the attention structure requires at least one learnable linear transformation. The input of the neural network for the second part of the model is the adjacency matrix E.

$$E = \{ {e}^{1} , {e}^{2} , … , {e}^{N} \} , e ∈ {ℝ}^{N}$$

which N represents the number of nodes, each eⁱ contains N values. For examples, Node 1 has a link with Node 2, then the value of E₁₂ will set to 1. If there is no link between Node 1 and Node 3, then the value of E₁₃ is 0.

Then the single linear transformation is applied on the adjacency matrix. Utilizing the weight matrix Wₗᵢₙₖₛ ∈ [symbol] . F′ represents the output size after this linear transformation, which should be the same size as the node features' output size. Then the output L as below is received. Moreover, lᵢ represents the output of of link features of node i in this layer.

$$L = E {W}_{l i n k s}$$

Therefore, the shape of output E′ is N—by—F′.

In the present invention, the attention mechanism utilizing a single linear neural network, parameterized by two vector a₁ ∈ [symbol] and a₂ ∈ [symbol] . The graph structure is injected into the model, which means only aᵢ is calculated for nodes j ∈ Nᵢ, where Nᵢ is neighborhood of node i in the graph. Neighborhood means the first-order neighbors of i. To make coefficients easily comparable across different nodes, across all choices of j using the softmax function is normalized. The value of aᵢⱼ represents the link importance score from node i to node j

$$A = {a}_{ij} = \frac{exp ( LeakyReLU ( {a}_{1} \times {l}_{i} + {a}_{2} \times {l}_{i} ) )}{{ς}_{}^{} {k ⊆ {N}_{i}}_{} exp ( LeakyReLU ( {a}_{1} {\times }^{} l + {a}_{2} \times {l}_{k} ) )}$$

### Matrix Computation in a Memory Efficient Way:

Assume there is an another attention weight matrix a₃ ∈

[symbol]

In the above equation, a₁×□ lᵢ+a₂×lⱼ is used to replace the equation of a₃[lᵢ∥lⱼ]. Where ∥ represents the concatenation operation. While the equation a₃[lᵢ∥lⱼ] represents a general form of the attention mechanism, our proposed equation provides a more memory-efficient alternative. Both equations ultimately produce the same results. However, our approach avoids storing the additional lᵢ and lⱼ term in memory, leading to significant efficiency gains. This optimization is crucial as every matrix in the code definition consumes memory.

Since the values for lᵢ and lⱼ are already readily available in memory, employing them directly within the attention mechanism eliminates the need for additional storage. Especially for the large scale dataset when there are millions of edges.

For public graph benchmarks like Cora, Citeseer and Pubmed: Finally, the mixing features

$${h}_{i}^{mix}$$

is received. The embeddings from neighbors h′j are aggregated together, and scaled by the link importance score aᵢⱼ. And applying an nonlinearity σ.

$${h}_{i}^{mix} = σ ( {\sum }_{j ∈ {N}_{i}}^{} {a}_{ij} {h}_{j}^{′} )$$

For fraud benchmarks like Yelp and Amazon:

After the aggregation, the method sums up it with the node features after linear transformation h′. In the context of fraud detection benchmarks, anomalous nodes (those flagged as fraudulent) frequently hold more critical information within their own features compared to their surrounding neighbors. As a result, instead of relying solely on link connections, retaining the features associated with each node is prioritized, allowing us to focus on the intrinsic characteristics of potential fraudulent entities. And the rest keep the same as above.

$${h}_{i}^{mix} = σ ( {\sum }_{j ∈ {N}_{i}}^{} {a}_{ij} {h}_{j}^{′} + {h}_{i}^{′} )$$

Then

$${h}_{i}^{mix}$$

can be used as the input for the prediction layer, which has a better representation and injects the link importance score from neighbor nodes.

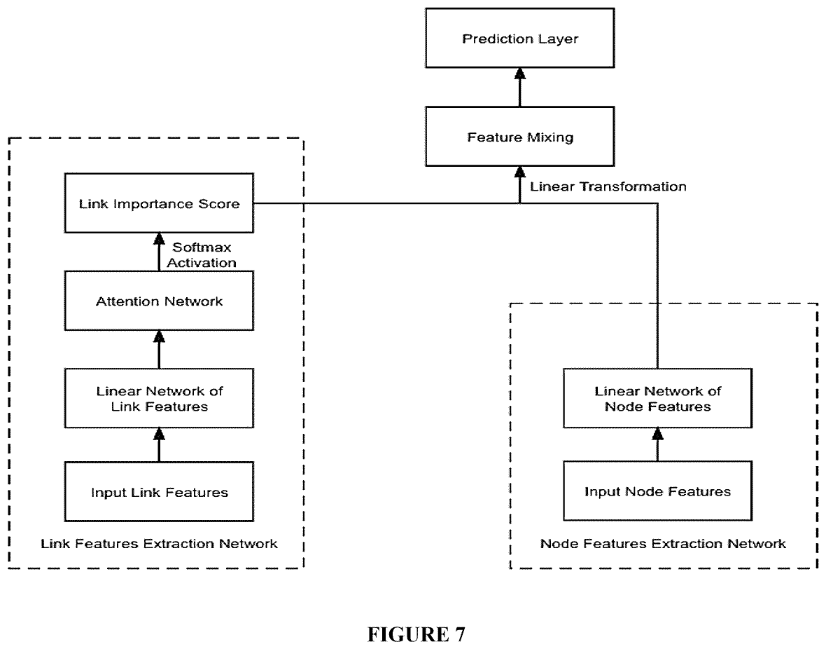

In accordance with an embodiment of the present invention FIG. 7 illustrates the architecture of the link attention network, a key component of the fraud detection method. The architecture is divided into two main networks: the Node Features Extraction Network and the Link Features Extraction Network. Both networks work together to generate a comprehensive representation of the transaction data for effective fraud detection.

On the right side, the Node Features Extraction Network begins with input node features, which represent the attributes of each transaction account. These features are processed through a linear neural network to obtain transformed node features. This transformation simplifies the original node attributes into a form that is more suitable for subsequent processing.

On the left side, the Link Features Extraction Network starts with input link features, representing the transaction behaviors between accounts. These features are fed into a linear network, which transforms them to a more useful representation. The transformed link features are then passed through an attention network that assigns importance scores to each link using a softmax activation function. The output of this process is the link importance score, which quantifies the impact of each link on the corresponding nodes.

The transformed node features and the link importance scores are then combined in a feature mixing stage. This mixed feature, which integrates both node attributes and the specific impact of each link, is subjected to a final linear transformation. The resulting combined feature is fed into a prediction layer, which utilizes this comprehensive representation to detect fraudulent transactions effectively. This architecture ensures that the model can accurately capture and prioritize the critical relationships and features within the transaction network, leading to improved fraud detection performance.

Some of the non-limiting advantages of the present invention are:
Improved Fraud Detection Accuracy: By leveraging link information and focusing on the significance of transaction behaviors between accounts, the invention enhances the accuracy of detecting complex fraudulent activities, including those involving multiple accounts or transactions.
Enhanced Scalability: The method employs memory-efficient attention mechanisms and advanced matrix computation techniques, allowing it to handle large datasets with millions of connections. This scalability makes the model practical for real-world applications in financial systems.
Increased Explainability: The invention outputs link importance scores that can be visualized in 2D or 3D, providing an intuitive understanding of the relationships and connections between accounts. This transparency aids in interpreting the model's decisions and identifying suspicious links.
Uncovering Hidden Relationships: By analyzing link importance scores, the model can uncover latent patterns in account relationships, aiding in the detection of sophisticated fraud schemes that might be missed by traditional methods.
Versatility: The invention is not limited to fraud detection. It can also be applied to other tasks such as node classification, link prediction, and recommendation systems, demonstrating its broad applicability and robustness in various financial transaction network applications.

Terms and phrases used in this document, and variations thereof, unless otherwise expressly stated, should be construed as open-ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art. Although the foregoing subject matter has been described in some detail by way of illustration and example for purposes of clarity of understanding, it will be understood by those skilled in the art that certain changes and modifications can be practiced within the scope of the appended claims.

What is claimed is:

1. A method for detecting fraud in financial transactions via a graph link attention network, comprising:
constructing a transaction network having nodes representing transaction accounts and links representing transaction behaviors;
extracting node features by a linear neural network to obtain transformed node features;
extracting link features, followed by applying a multi-head attention mechanism to generate link importance scores, wherein the link importance score for each link represents impact on the corresponding node and the sum of the importance scores for all links of each node equals to 1;
combining the transformed node features and the link importance scores to form mixed features; and
utilizing the mixed features to identify fraudulent transactions within the transaction network.

2. The method of claim 1, wherein the node features include at least one of the following: basic information of the trading account, transaction type, and transaction amount.

3. The method of claim 1, wherein the transaction network is visualized in a 2D or 3D graph based on the link importance scores to facilitate the identification of suspicious links.

4. The method of claim 1, further comprising uncovering latent relationships between accounts by analyzing the link importance scores.

5. The method of claim 1, wherein the multi-head attention mechanism applies multiple sets of attention functions in parallel to the link features to enhance the learning of link importance scores.

6. The method of claim 1, wherein the link importance scores highlights links with higher fraud likelihood.

7. The method of claim 1, wherein the mixed features are used for node classification to identify fraudulent accounts within the transaction network.

8. The method of claim 1, wherein the mixed features are used for link prediction to predict the likelihood of a financial transaction occurring between two accounts.

9. The method of claim 1, wherein the mixed features are used for recommendation systems to suggest potential transactions between accounts based on their relationships within the transaction network.

10. The method of claim 1, wherein the model outputs a fraud likelihood score for each node based on the combined link importance scores and node feature.
